(19) United States
(12) Patent Application Publication
(10) Pub. No.: US 2026/0214402 A1
(43) Pub. Date: Jul. 23, 2026

(54) METHOD OF DIGITAL ROOM ACOUSTICS COMPENSATION (DRC) FOR AUDIO OUTPUT SYSTEM PLACED IN ROOM, DIGITAL ROOM ACOUSTICS COMPENSTATION SYSTEM (DRC), AND AUDIO SYSTEM

(71) Applicant: Tymphany HK Limited, Wanchai (HK)

(72) Inventors: Sebastiaan de Vries, Taipei City (TW); Jyri Pakarinen, Taipei City (TW)

(21) Appl. No.: 19/032,822

(22) Filed: Jan. 21, 2025

(51) Int. Cl. H04S 7/00; G06F 3/01

(52) U.S. Cl. CPC H04S 7/301; G06F 3/017; H04S 2400/01

(57) ABSTRACT

A method of digital room acoustics compensation (DRC) for an audio output system placed in a room includes establishing a wireless communication link between a DRC system and true wireless stereo earbuds; sending an activation instruction to the earbuds, the activation instruction including instructions for activating the microphones of the earbuds; instructing the audio output system to output an audio test sound to be received by the microphones; receiving, from the earbud, first digital signals, representative of captured audio test sound; performing digital signal processing on the first digital signals, the digital signal processing including room impulse response audio signal processing to generate one or more time and/or frequency domain correction filters; and at least temporarily storing the one or more time and/or frequency domain correction filters for application and correcting audio input signals of the audio output system before outputting the audible audio via the audio output system.

### FIELD OF THE INVENTION

The present invention relates to a method of automated or semi-automated digital room acoustics compensation (DRC) for an audio output system placed in a room, to a digital room acoustics compensation (DRC) system, and to an audio system.

### BACKGROUND OF THE INVENTION

According to known technology, when placing an audio system, such as a soundbar, a smart speaker, several hi-fi-speakers, or any appliance that reproduces sound in a room, its acoustic performance, in particular the audible audio to be received by a listener, may be drastically impaired by the acoustic characteristics of the room and objects placed within the room. Reflective objects such as walls, ceilings, and furniture in general modify the original content of audible audio by introducing amplitude, time, and phase errors over its entire frequency band. Standing waves may cause acoustic nulls (cancelation) and acoustic peaks due to the nature of room acoustics. With modern surround sound applications, such as spatial audio, 3D audio, Dolby Atmos, DTS, etc., the challenge becomes even more significant as such systems have multiple channels of audio simultaneously outputting identical sound, i.e., audible audio, into the room, e.g., a living room or any other room in a building or anywhere else. Individual timing and time alignment of different audio channels in a surround sound setup are largely unpredictable and are compromised in substantially any room.

According to some solutions, the phase and time response can be corrected and appropriate time delays may be added to individual audio channels.

However, the known approaches for DSC still leave room for improvements, in particular with regard to efficiency, simple implementation and/or accuracy.

### SUMMARY OF THE INVENTION

It is therefore an object of the invention, to provide a method for automated or semi-automated digital room acoustics compensation (DRC) for an audio output system that is placed in a room and is provided for outputting audible audio into the room for listening by a (human) listener. Further, a corresponding room acoustics compensation (DRC) system, a system comprising such a DRC system and an audio system shall be provided.

This object is solved by the combination of features of the independent claims. Embodiments result from the dependent claims and the exemplary embodiments described below and in connection with the annexed figures.

In accordance with an embodiment, a method of automated or semi-automated digital room acoustics compensation (DRC) for an audio output system is provided. The audio output system, comprising, for example, a soundbar, a smart speaker, several hi-fi-speakers, or any appliance that reproduces sound in a room for providing audible sound or audio to a listener, is placed in a room. The room may for example be a living room, a room in a building or in any other location. Specifically, the audio output system is configured for outputting audible audio into the room. The audio system may have several channels for outputting the audio.

The DRC underlying the method is based on room impulse response (RIR) audio signal processing. Room Impulse Response (RIR) relates to a technique that is used to characterize how sound propagates and interacts within a room. By capturing for example the impulse response, it is possible to analyze the acoustic properties of the room, such as reverberation time, frequency response, and reflection patterns. This information used for correcting the output of an audio system to compensate for disturbances caused by the characteristics of the room, including objects, such as furniture, drapery etc. Hence, RIR may provide optimized audible audio output of an audio output system placed in the room. The method may be carried out by the DRC system. The DRC system may be integrated into an audio output system, or be implemented as a separate component and connected with the audio output system via cables or a wireless connection.

The method comprises:
i) Establishing a wireless communication link between a DRC system, i.e., a system for performing or carrying out DRC, and a first and second true wireless stereo (TWS) earbud. The first and second TWS earbud each comprise a microphone, in particular a beamforming microphone, for capturing audio. After establishing the wireless communication link, the DRC system and TSW earbuds may be configured for wireless digital signal exchange, in particular from the DRC system to the TWS and vice versa. TWS earbuds including one or more microphones are known in the art.
ii) In response to establishing the wireless communication link, in particular after successful mediation between the components, the method comprises sending an activation instruction to the first and second TWS earbud, wherein, for performing the subsequent method steps, the first and second TWS earbud are placed or are to be placed in a left and right ear of a human listener. Specifically, one of the TWS earbuds is placed in the right ear, and the other one is place in the left ear. The activation instruction comprises instructions for activating the one or more microphones of the first and second earbud. This means that the earbuds each comprise a microphone, and the activation instructions are for enabling the DRC system to receive signals from the earbuds related to sound or audio recorded by the microphones.

In response to receiving a confirmation confirming successful setting up of the wireless communication link, e.g., in response to receiving or detecting a confirmation signal from the earbud or another entity in communication with the DRC system and/or earbuds confirming successful setting up the wireless communication link, the method further comprises:
iii) Instructing the audio output system placed in the room, in particular one or more audio speakers, in case of several speakers or channels in particular one after the other, to output one or more, in particular a sequence of, audio test sound (or tones) adapted to be received by the activated microphones of the first and second TWS earbud. The audio test sound may be, due to the activation of the microphones, recorded by the microphones of the TWS earbuds. The recorded audio may then be communicated or retrieved via the wireless communication link to or from the DSC system, based for example on digital signals encoding or representative of the recorded audio.

Accordingly, the method may proceed with:
iv) receiving, from the first and second earbud, one or more or a sequence of first digital signals, each first digital signal representative of one or more, or a sequence of captured audio test sound;
v) performing, in particular software-based, digital signal processing on the one or more, or the sequence of first digital signals, the digital signal processing comprising room impulse response (RIR) audio signal processing, to thereby generating one or more time and/or frequency domain correction filters, which, for the purpose of the current disclosure shall include all corrective measures calculated or determined by the DRC system; and
vi) at least temporarily storing the one or more time and/or frequency domain correction filters for application and correcting audio input signals of the audio output system before outputting audible audio corresponding to the audio input signals via the audio output system, e.g., via the (in particular two or more) speakers of the audio output system.

Accordingly, the suggested method involves recoding the audio test sound via a microphone of the TWS earbuds, and providing corresponding signals to a digital room acoustics compensation (DRC) system for DRC. During DRC, the TWS are placed in the listener's ears, which enables exact and efficient DRC in view of the fact that the microphones are as close as possible to the listener's ears and mirror the location and orientation of the listener's ears. Further, the suggested method is comparatively easy and convenient for a user/listener who wants to carry out a DRC measurement and/or analysis.

Further, because the earbuds are placed in the listener's left and right ear and the test signals are recorded by both earbuds, optimal results for obtaining reasonable DRC can be obtained. Specifically, placing the earbuds in both ears of the listener closely models how the listener's ears perceive sound, in particular with regard to location and orientation (of the ears) in space relative to the audio output system, in particular two or more speakers, a soundbar etc. Using the earbuds in both ears as suggested has the advantage, for example over one-dimensional systems using only a single microphone placed in the room, that information about the (exact) location of the sound in space may be assessed, which may be an advantage for correcting the root of the acoustic errors.

The suggested method steps relate to the point of view of a DRC system communing with the earbuds, and possible other components. Other point of views, e.g., from one or both earbuds or additional devices, such as mobile devices like smartphones, tablets, computers, smart-TVs mediating communication between the DRC and TWS earbuds, for example, shall also be included. In such cases, the digital signaling direction, e.g. the exchange of wireless signals, is changed (sending vs. receiving).

Further, the method shall not be limited to direct wireless interactions between the DRC system and the earbuds, but shall also comprise wireless interactions mediated by a device suitable for wireless communication with the DRC system and the earbuds. For example, a mobile device, such as a smartphone, a tablet, a computer, a smart device, such as a smart TV etc., may be provided, including software, such as an application (App), which, when executed on the device (one or more processors) is able to mediate, at least in part, data communication between the DRC system and the earbuds and/or execution of the DRC. As an example, a smartphone including a user interface with a display may include software, e.g. App, enabling a user to select a DRC system and earbuds available and recognized in the wireless range of the smartphone. The App may be configured to enable the user to set up wireless connections between the DRC and earbuds, start or stop DRC, select operational modes, and/or may enable configurational settings for the DRC. Further, the display of the user interface of the smartphone may be used for providing (visual) instructions for the listener or user in connection with carrying out the DRC, e.g. instructions to the listener in connection with putting the earbuds in listener's ears, taking a preferred listening position in the room, moving to a different listening position, keeping head steady, moving head etc. When using an App, the listener as well as a third person may perform or activate the DRC.

In some embodiments, instructions for the listener may be provided to the listener via speakers of the earbuds. For example, an instruction to move to a preferred listening position in the room may be provided acoustically over the earbuds. In some embodiments, the microphones of the TWS earbuds may be used for receiving spoken commands from the user or listener, the commands representing instructions for the DRC system for carrying out the DRC. For example, the commands may relate to instructions for carrying out the DRC measurement, such as “start DRC measurement”, “stop DRC measurement”, “preferred listening position reached” etc.

In some embodiments, the method may further comprise applying the one or more correction filters to audio input systems before outputting audible audio via the audio output system, in particular via two or more speakers. This means that the correction filters obtained or determined previously may be subsequently, after finishing the DRC measurement and analysis, applied to audio output.

In some embodiments, the wireless link is based on a short-range wireless communication protocol, (e.g. Wi-Fi, Bluetooth, Zigbee, Z-Wave). In particular, the DRC system and earbuds, and, if applicable, the further device, may comprise wireless communication components suitable for wireless communication according to the communication protocol.

In some embodiments, the activation instruction may comprise one or more second digital signals for instructing the one or more earbuds to output a first audible information via the earbud's speakers, the first audible information indicating to the listener that DRC measurement is, is about to be activated, is in progress and/or was finished. The audible information may for example comprise a beep or tone etc., or may include speech output, such as “DRC measurement activated” or “DRC measurement in progress” etc. In the alternative or additionally, corresponding information may be provided, based on the second one or more digital signals of the activation instruction, on a display of a user interface of a mobile device in wireless communication with the DRC system and/or earbuds and involved in the DRC measurement, for example.

In some embodiments the activation instruction may comprise one or more third digital signals for instructing the one or more earbuds to output a second audible information via the earbud's speakers, the second audible information instructing the listener to move to a particular location within the room. The particular location may relate to the preferred listening position of the user within the room, where it is advantageous to carry out the DRC measurement if the user is in the preferred listening position. Reaching the particular position may be detected by the DRC system for example via location tracking of the earbuds and/or by receiving a confirmation signal, e.g., a voice input via microphones of the earbuds and/or manual confirmation such as an input on a user interface of the mobile device involved in the DRC, an input at a button or touch-sensitive are at the earbuds, etc. Respective communication pathways and the possibility for interacting with the listener or user greatly facilitate execution of DRC and DRC measurements, meaning that even laypersons may perform the DRC.

In some embodiments, the method may further comprise receiving from a location and/or orientation tracking unit of one or more of the two earbuds via the wireless link one or more, or a sequence of fourth digital signals, the fourth digital signal encoding location and/or orientation information of a respective earbud, in particular relative, to the room, and the method may comprise correlating a location and/or an orientation information obtained from the fourth digital signal with one or more of the first digital signals, the first digital signal received substantially simultaneously, or immediately before or after the fourth digital signal. Accordingly, the DRC system may determine the orientation and/or location of the earbuds, i.e., the microphones for detecting or recording the test signals, on its own, in particular in an automated manner. In this way, the DRC measurements may be performed continuously. Further, several DRC measurements may be performed while the listener or user is moving through the room to thereby obtain DRC for several (preferred) locations, for example. If DRC is carried out for several locations in the room, the DRC system may store DRC functions associated with respective locations, and the DRC system may be configured to receive a selection of a location and in response to receiving the selection, apply the DRC functions for the selected location. Selecting a location may be signaled to the DRC system via voice and/or manual input, e.g., over the earbuds, and/or over the mobile device. In the alternative, the DRC may be carried out, such that filters are generated to optimize audio over several locations or an area of the room. In some embodiments, the location tracking may be external, e.g. using one or more cameras and/or distance measuring systems (e.g., LIDAR etc.).

In some embodiments, the method may involve carrying out the steps iii) to vi) repeatedly, for example for different locations in the room. The time and/or frequency domain correction filters may, at least temporarily, be stored together with location and/or orientation information, for application and correcting audio input signals of the audio output system before outputting the audible audio via the audio output system. In some embodiments, the filters may be applied in dependence of a location and/or orientation information signal received from the earbuds and/or the location tracking system during playing audio.

In some embodiments, the method may further comprise determining whether a location and/or orientation encoded in the fourth signal has changed, and, in response to determining a change, for example by determining by the DRC system or an associated mobile device that a current location differs from a previous location by more than a given a threshold, the method may comprise repeating steps iii) to vi) and at least temporarily storing previously generated correction filters together with previously determined location and/or orientation information. The stored location-specific DRC data may be applied by the DRC system if a corresponding location is selected, for example over voice or manual input on a mobile device displaying available locations and/or over a voice input received over the microphones of the earbuds. In the alternative or additionally, the information obtained for the different locations may be merged to obtain one or more filters suitable for correcting audio over a certain area or space including two or more of the locations.

In some embodiments, the RIR audio signal processing may comprise one or more of an analysis of the frequency response, a time representative of a delay between sending an audio signal and receiving the audio signal, an amplitude of received audio, a location of a sound source for outputting the audible audio, and an analysis of direct and reflected outputted audio. The delay may for example include delays caused by wireless communication between the DRC system and the TWS earbuds. Such time delay may be corrected for. Direct and reflected audio may for example be recorded by using beamforming microphones, in particular multiple beamforming microphones, implemented at the TWS earbud.

In some embodiments, the one or more time and/or frequency domain correction filters may comprise at least one of an inverting filter to correct individual audio channel's frequency response, a time-domain alignment filter to each of several audio channels so that audio of different channels arrive at the buds substantially at the same time, an amplitude correction filter so that all channels are calibrated at a predetermined value of sound pressure level, in particular at 75 dBSPL (SPL: Sound Pressure Level), at a listening position; phase correction filters to compensate for phase shift caused by positioning and reflective surfaces of audio output speakers. Respective filter or filter elements are suitable for obtaining efficient DRC.

In some embodiments, and as briefly discussed further above, the method may involve a mobile communications device, in addition to a DRC system or system component and the earbuds. Accordingly, the method may comprise establishing a further wireless link between the DRC system and the mobile communications device, the device comprising a user interface. The mobile communications device may be configured for receiving, from the DRC system ore or more fifth digital signals for instructing the user interface to display DRC information to a listener. Further, the DRC system may receive from the mobile communications device, responsive to a user-input on the user-interface, one or more sixth digital signals indicative of one or more of an indication of a location of the listener at a particular location in the room, a confirmation to start DRC, an indication of a type and configuration of the earbuds, an instruction to stop DRC, and a configuration setting for the DRC. Information encoded in the sixth signals may be used by the DRC System in connection with carrying out DRC. This means, that the device may be used for, at least in part, mediating communication between the DRC system and the earbuds, and may provide control options for the listener for carrying out, at least in part, DRC measurements and analysis.

In some embodiments, a digital room acoustics compensation (DRC) system for automated or semi-automated digital room acoustics compensation for an audio system that is placed in a room and that is provided for outputting audible audio into the room is provided. The system comprises digital signal processing circuitry configured to, and/or comprises a non-transitory storage medium, storing instructions that when executed by one or more digital processing units, cause the system to execute a method comprising the steps of any embodiment described herein in connection with the suggested method.

In some embodiments, a system comprising a digital room acoustics compensation (DRC) system in accordance with one of the embodiments described herein in connection with the invention, and comprising a first and second true wireless (TWS) earbud, wherein the first and second TWS earbud comprising hardware components, in particular a microphone, in particular a beamforming microphone, and digital signal circuitry configured for use in a method according to any embodiment described herein in connection with the invention.

In some embodiments, an audio system is provided comprising a DRC system according to any embodiment described herein in connection with the invention, or comprising a system as previously described, the audio system further comprising two or more audio output elements including one or more audio speakers for outputting audible audio into the room.

### BRIEF DESCRIPTION OF THE DRAWINGS

Non-limiting examples will now be described in connection with the accompanying drawings. Same or functionally corresponding elements are referenced with same reference signs. In the drawings:

FIG. 1 shows is an exemplary setup for DRC in a room;

FIG. 2 shows a pictorial representation of exemplary steps for performing DRC measurement and correction;

FIG. 3 shows a process diagram in connection with an exemplary DRC method; and

FIG. 4 shows a schematic flow diagram in connection with an exemplary DRC method according to FIG. 3, including one or more optional process steps.

### DETAILED DESCRIPTION

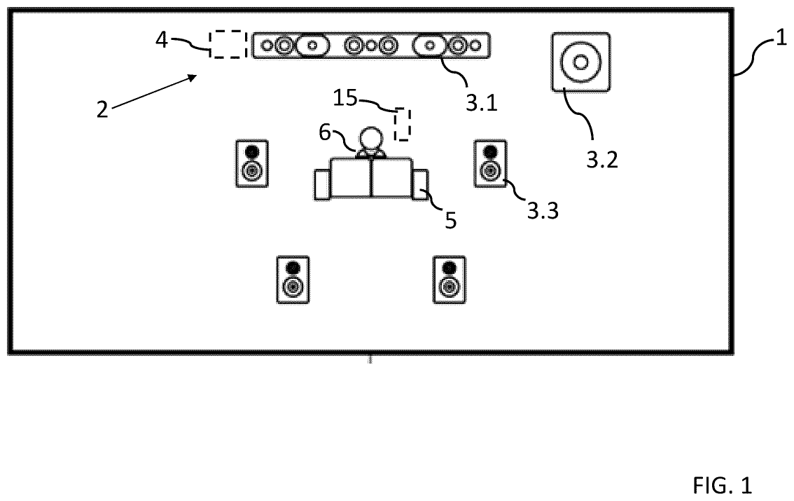

FIG. 1 shows an exemplary setup for DRC measurement and analysis in a room 1, e.g., a living room. In the room, there is an audio output system 2 comprising several speakers, for example a soundbar 3.1, one or more bass speakers 3.2, and one or more satellites 3.3, generally referred to as speakers.

A DRC system 4 for digital room acoustics compensation (DRC) is provided. The DRC system 4 may be part of the audio output system 2, and is shown in FIG. 1 only schematically by a dashed rectangle. The DRC system 4 may comprise one or more processors and/or digital circuitry for performing a DRC method according to any embodiment described herein.

In the room 1 there is further a couch 5 on which a listener 6 has taken seat. The couch 5 is only an example for a piece of furniture representative of a preferred listening location. Further, other pieces of furniture may be placed in the room.

For the purpose of the present disclosure, the couch 5 on which the listener 6 has taken seat represents the listener's favorite listening location, for which DRC shall be performed. It is to be understood that DRC may be performed with regard to any other location in the room 1.

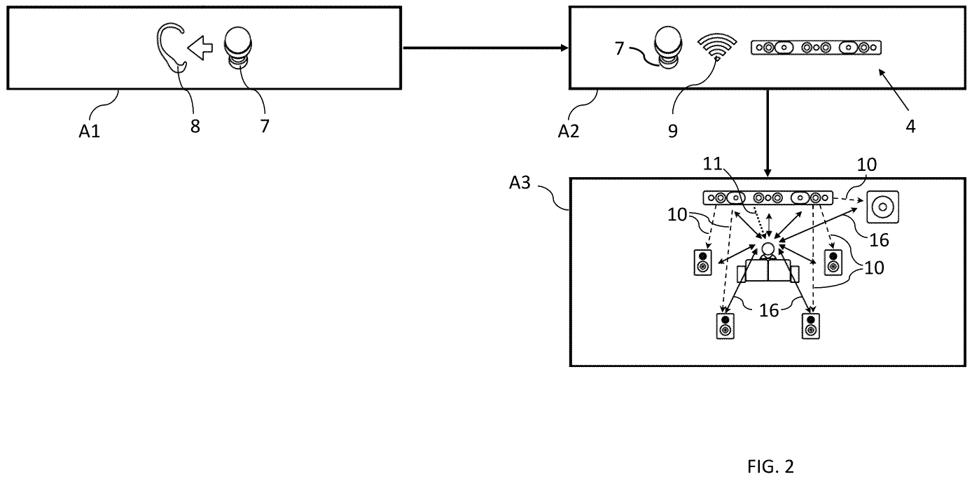

FIG. 2 shows a pictorial representation of exemplary steps and actions for performing DRC measurement and correction.

Starting with the setup shown in FIG. 1, a first action A1 may comprise inputting a left and right TWS earbud 7 into the left and right ear 8 of the listener 6. The listener 6 may be instructed by the DRC system 4, for example, via the DRC system 4 itself or the earbud 7, to do so and to move or occupy the preferred listening location, which is the couch 5 as shown in FIG. 1. Although the present invention is illustrated using earbuds as an example, it is understood that in other embodiments, headphones can also be used for implementation.

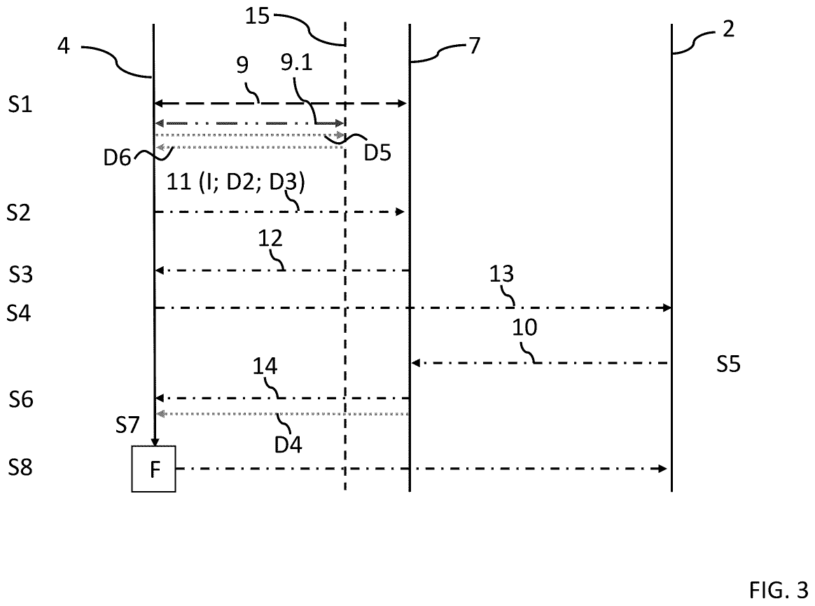

Having placed the earbuds 7 into the ears 8, a next action A2 may comprise setting up a wireless link (or communication) 9 between the earbuds 7 and the DRC system 4. Having established the wireless link 9, the DRC system 4 is ready for performing DRC analysis and measurements, as illustrated in action A3. Specifically, the DRC system 4 sends audio test signals 10 (indicated by dashed arrows in FIG. 2) to control and instruct the speakers of the audio output system 2 to output one or more and/or a sequence of audio test sound (or tones) 16 (indicated by solid double arrows), and the DRC system 4 sends a control signal (e.g., an activation instruction 11 shown in FIG. 3) to control the earbud 7 to detect the audio test sound 16. The audio test sound 16 is preferably outputted separately from each speaker 3 one by one for each channel of the audio output system 2. The audio test sound 16 is then recorded or detected by beamforming microphones comprised by the earbuds 7. Followingly, the earbuds 7 send the first digital signal of the received audio test sound detected by the beamforming microphones to the DRC system 4 for subsequent the DRC analysis and calibration/correction.

The audio test sound 16 may comprise sweep tones and/or pink noise to obtain the combined frequency and time-domain response of the speakers 3 and the room 1. The DRC analysis may comprise determining by the DRC system 4 a distance between a (or the) speaker 3 and the beamforming microphone, in particular the earbud 7. The analysis may further comprise determining a sound pressure level (SPL) and a frequency response, respectively for each channel (or each speaker) of the audio output system 2. Based on respective analysis and signal processing, the DRC system 4 may then determine and provide correction filters for each channel (or each speaker). The correction filters may provide corrective actions such as a correction of time delay such that sound from different speakers 3 arrives at the listener's ears 8 simultaneously, and a correction or calibration of the SPL, for example such that sound from each speaker 3 is at e.g. 75 db SPL at the listener's ears 8. Further, the DRC system 4 may determine or calculate inverted (or inverse) equalization (eq) response filter, such that, by applying the filters to produce audio input signals of the audio output system 2 before outputting the audible audio/sound via the speakers 3, making all channels follow a predefined target frequency curve at the earbuds 7 for the listener's ears 8. The latter is possible, in particular, because the audio test sound 16 is recorded or measured immediately at the listener's ear 8 via the built-in microphones of the TWS earbuds 7.

After determining and calculating all correction filters by the DRC system 4, the system and listener's position is calibrated to the room, in particular with regard to physical distance, amplitude and frequency response. The correction filters may, at least temporarily, be stored, for example in connection with listener location information on the preferred listening location. The listener location information can be defined in two ways: (1) the distance between the listener's earbud 7 and each speaker 3, or (2) the relative distance and orientation between the listener's earbud 7 and the DRC system 4. When adopting definition (2), it is necessary to know the relative position between the DRC system 4 and each speaker 3.

FIG. 3 shows a process diagram for a method of automated or semi-automated digital room acoustics compensation (DRC) for an audio output system 2 placed in a room 1 and configured for outputting audible audio into the room 1, wherein the DRC is based on room impulse response (RIR) audio signal processing.

In a first step S1, a wireless communication link 9 between the DRC system 4 and the TWS earbuds 7 is set up. The wireless communication link 9 is based on a short-range wireless communication protocol; for example, it may be established via Wi-Fi.

In response to establishing the wireless communication link 9, the method comprises a second step S2, sending an activation instruction 11 (indicated in FIG. 2 by a dotted arrow) to the earbuds 7. Before or after that, the earbuds 7 are to be placed in the listener's ears 8. The activation instruction 11 may comprise instructions I for activating the beamforming microphones of the earbuds 7 and informing the listener 6 to be seated at a listening location.

In a third step S3, in response to receiving a confirmation 12 confirming successful setting up of the wireless communication link 9 and confirming that the listener 6 is seated at a final listening location, the method may proceed to a fourth step S4, which instructs the audio output system 2 placed in the room 1 to output one or more, in particular a sequence of, audio test sound 16 over the speakers 3 (e.g., for each channel one by one), by sending a corresponding output instruction 13 including the audio test signals 10 to the audio output system 2, then, each speaker 3 produces corresponding audio test sound 16 according to its audio test signal 10, wherein the audio test signals 10 are adapted to generate the corresponding audio test sound 16, which is received by the activated beamforming microphones of the earbuds 7. Accordingly, in step S5, the audio output system 2 outputs the audio test sound 16, which is/are recorded or detected by the microphones of the earbuds 7.

Subsequently, in step S6, the method involves receiving process from the earbuds 7, one or more, or a sequence of first digital signals 14, each first digital signal 14 representative of one or more, or a sequence of captured signals corresponding to the audio test sound 16.

In some embodiments, step S6 may optionally comprise receiving from a location and/or orientation tracking unit of one or more of the two earbuds 7 via the wireless communication link 9 one or more, or a sequence of fourth digital signals (indicated in FIG. 3 by a dotted arrow), the fourth digital signal D4 encoding location and/or orientation information of a respective earbud 7, for example relative to the speaker 3 in the room 1. The location and/or an orientation information obtained from the fourth digital signal D4 may be correlated with one or more of the first digital signals 14, and used for processing in subsequent steps. The first digital signal 14 may be received substantially simultaneously, or immediately before or after the fourth digital signal D4.

In response to receiving the first digital signals 14, in step S7, the DRC system 4 performs digital signal processing on the one or more, or the sequence of first digital signals 14. The digital signal processing may comprise room impulse response audio signal processing to thereby generate one or more time and/or frequency domain correction filters F.

After the DRC measurements and corresponding signal processing for determining the filters F and determining corrective measures, the DRC system 4 may at least temporarily store the one or more time and/or frequency domain correction filters. Further, the filters F may be applied in subsequent audio output via the audio output system 2. Particularly, in step S8, the filters F and corrective measures may be applied to audio input signals of the audio output system 2 before outputting the audible audio (or: sound) via the speakers 3. The correction filters F are used to calibrate the audio input signals that will then be provided to the speaker 3 of the audio output system 2 to produce sound, making the subsequent sound (audible audio) received by the earbuds 7 from the speaker 3 matches the preset ideal value. After the calibration is completed, the listener 6 can remove the earbuds 7. Subsequently, the sound heard by the listener 6 will represent the optimal audio performance after calibration. In other words, this audio performance eliminates acoustic errors caused by spatial acoustic effects (e.g., reflections or voice delay) and speaker positioning, calibrating room 1 to a state closer to the ideal condition of the sound source.

Any further embodiment as discussed further below and above may be applied to the exemplary embodiment described in connection with the figures.

In particular, in connection with step S2 and the activation instruction 11, the activation instruction 11 may, in addition to providing the instructions I for activating the beamforming microphones of the earbuds 7, provide other types of or additional (digital) instructions to the earbuds 7 based on digital signals. Respective digital signals may be provided together with the instruction I in a single activation instruction or in multiple, separate activation instructions. For example, an activation instruction 11 may additionally comprise one or more of a second digital signal D2 or a third digital signal D3. The second digital signal D2 may for example be provided for instructing the earbuds 7 to output a first audible information via the earbud's speakers, the first audible information indicating to the listener 6 that DRC measurement is, is about to be activated, is in progress, and/or was finished. The third digital signal D3 may for example be provided for instructing the earbuds 7 to output a second audible information via the earbud's speakers, the second audible information instructing the listener 6 to move to a particular location within the room 1.

In some embodiments, communications between the DRC system 4 and the earbuds 7 may at least in part be mediated by a mobile device, such as a smartphone, a tablet, a smart device, a smart television etc. enabling user interaction via a user interface. A corresponding mobile device 15 is schematically indicated in FIGS. 1 and 3, wherein, as indicated in FIG. 3, communications between the DRC system 4 and the earbuds 7, and if required, with the audio output system 2 may be mediated and/or controlled via wireless links established between respective devices by the mobile device 15.

In some embodiments, and as schematically shown in FIG. 3 via a dash-dotted double arrow, a further wireless link 9.1 to the mobile communications device 15 may be established. The mobile communications device 15 may comprise a user interface. Further, the device 15 may be configured for receiving, from the DRC system 4, one or more fifth digital signals D5 for instructing the user interface (not shown) to display DRC information to the listener 6. Alternative or in addition, the method may comprise receiving, at the DRC system 4, from the mobile communications device 15, and responsive to a user-input on the user-interface, one or more sixth digital signals D6 indicative of one or more of an indication of a location of the listener 6 at a particular location in the room 1, a confirmation to start DRC, an indication of a type and configuration of the earbuds 7, an instruction to stop DRC, and a configuration setting for the DRC. The fifth and sixth digital signals D5 and D6 are indicated in FIG. 3 as dotted arrows.

The suggested methods and system(s) in particular provide the advantage of simplified user experience. Particularly, no wired connection is required, and placement of the microphones for recording the audio test sound is simplified, wherein, by using the earbuds 7, the recording location perfectly matches the location of hearing later audible audio outputted form the audio output system 2. It is sufficient that the user/listener 6 inserts the TWS earbuds 7 in the ears 8, sits or positions themselves at the desired or preferred listening location (which is the couch 5 in FIG. 1), and lets the system calibrate the room 1 mode effect by utilizing the microphones built into the TWS earbuds 7.

Further, the methods and system(s) provide predictable results, because the systems “listens” to the room 1 from the point of view of the user's ears 8. Thus, the DRC system 4 hears what the user hears. Specifically, it can be assured that measurements are taken from the height position and location of the listener's ears 8 in the respective location. This is advantageous as it is crucial with regard to standing waves, e.g., room modes, which vary significantly when moving to different locations in a room 1.

In particular, it may be guaranteed that the measurement location is exactly at the listening height in the preferred listening position, wherein the suggested method and system(s) are able to conduct stereo measurements, and are able to include the interaction between multiple speakers 3, as there are at least two microphones (at least one in each earbud 7). By using beamforming microphones inside a TWS earbud 7, it is possible to measure, in the time-domain, allowing for (better) time alignment of multichannel immersive audio setups.

In some embodiments, TWS earbuds 7 having multiple, e.g. an array of beamforming microphones may be used. By this, 3-dimensional room data may be recorded and considered in the corrective measures, in particular filters. Hence, improved phase and time-domain corrections may be obtained by locating the sound source in 3D acoustic data from the room 1, in particular data related to the time and space domain, allowing for frequency, amplitude, time-domain, and/or phase corrections. It is to be noted that beamforming microphones are usually configured to differentiate between direct and reflected soundwaves, which information may also be used for setting up corrective measures, in particular the filters F.

An exemplary sequence of steps for carrying out a DRC may include:
1) Take a preferred listening position with the TWS earbuds 7 inserted in both ears 8. After placing the TWS earbuds 7 in the ears 8 and/or seating at the preferred listening position, a signal may be sent to the DRC system 4 from the earbuds 7 or the device 15 to start the calibration process. This may for example involve a user (i.e., listener 6) interaction with a user interface on a mobile device (such as device 15), e.g., a user pressing or interacting with a confirmation button presented on a screen of a mobile device, the screen generated by an App related to the room calibration. In the alternative, or additionally, the confirmation may be generated by a user pressing or interacting with a (touch sensitive) button, gesture sensitive camera (gesture sensor) or a touch panel on the earbuds 7. Further, as an alternative, the calibration may start automatically, for example, after the expiry of a counter started after sending an instruction to take the preferred listening position for which the room calibration shall be carried out. As mentioned, the instruction may be at least one of audio over the earbuds 7, gesture control and visual on a display screen of a device (smartphone, TV, etc.). For example, when the listener has put on the earbuds 7 and is seated in the preferred/appropriate position, he can perform a hand gesture for the gesture sensor of the earbuds or speak to the beamforming microphones of the earbuds 7. Upon detecting the gesture or speech, the earbud 7's IC controller sends an instruction signal to the DRC system 4 to notify the listener has put on the earbuds 7 or is seated in the appropriate position.
2) Playing, by the DRC system 4 via the audio output system 2, a series of audio test sounds (or tones), in particular multi-test-tones at a reference level of e.g. 75 dB SPL, are produced through all channels of the audio output system 2, one by one, respectively.
3) Measuring or determining by the DRC system 4, based on the sound recorded by the beamforming microphones of the earbuds 7: a) frequency response b) time c) amplitude d) sound source location e) direct and reflected sound.
4) Optionally, prompting the user 6 to take place in off-axis seating positions for more measurements.
5) Calculating by the DRC system 4 an audio-setup: 1) inverting filters to correct individual channels'in-room frequency response, 2) time align each channel so they all arrive at the ears at the same time, 3) correct each channels amplitude so they are all calibrated at a certain value, such as 75 dB SPL at the listening position 4) in particular embodiments, the DRC system 4 may calculate phase correction filters to compensate for phase shift caused by speaker positioning and reflective surfaces. In particular, the DRC system 4 may calculate or determine a correction algorithm, a series or combination of IIR (Infinite Impulse Response) or FIR (Finite Impulse Response) inversion filters. For the purpose of the present disclosure, the term “filter” shall cover all corrective measures determined by the DRC system 4.
6) Storing the audio-setup, including the filters/corrective measures. After that, the system is calibrated to the room 1 and comes closer to the source by eliminating errors caused by room acoustics effect and speaker placement. This audio performance eliminates acoustic errors caused by spatial acoustic effects (e.g., reflections or voice delay) and speaker positioning, calibrating room 1 to a state closer to the ideal condition of the sound source.

An advantage of particular embodiments is that earbud-integrated units for determining location and orientation of the earbuds and hence the head/ears of the listener 6, such as IMU (inertial measurement unit) head-tracking sensors integrated in TWS earbuds 7, may be used. While capturing the audio test sound (or tones) 16, the location and/or orientation of the earbuds 7 of the listener 6 may also be recorded and used for determining or calculating filters/corrective measures. In some embodiments, each of the earbuds 7 is equipped with a position sensor, such as an infrared sensor, capable of detecting the distance and orientation between each earbud 7 and each speaker 3. This generates a relative positional orientation of the earbuds 7, enabling the DRC system 4 to produce a corresponding correction filter F for each relative position and orientation of the earbuds 7. These correction filters F are stored in memory to create a lookup table, allowing the DRC system 4 to directly retrieve the applicable correction filter F when it subsequently detects the relative position and orientation of the earbuds 7. In some embodiments, the DRC system 4 may read the location and/or orientation data, e.g., from TWS earbuds 7, to determine when the listener 6 has stopped moving, and, in response to that, may start to send or play the audio test signals 10 or audio test sound (or tones) 16. A benefit may be that the measurement process may be carried out continuously, and the listener 6 may just be told to “start from the main listening position and walk around the listening room”. Associating the head/ear location and/or orientation data obtained from respective sensors with the captured microphone signals may simplify measurement of multiple listening positions, without requiring separate, subsequent measurement rounds. The DRC system 4 may be configured, based on corrective measures available for different locations and/or orientations, to automatically tune to the optimal sound for a listening position (including location and/or orientation).

In some embodiments, data obtained from different locations may be used to calibrate the audio output system 2 to the room 1 such that, acceptable audio response is present also in other locations different than the preferred listening position, which is a common problem in room compensation—trying to make the preferred listening location perfect, will make other positions sound bad.

According to some embodiments, a series of preset locations and/or audio-setups may stored—these relating to adjusting the sound in the room on the basis of a varying number of users being located at various positions in the room. Evidently, setting up the soundscape for one listener located in front of the speakers may be different if multiple listeners are present in different areas of the room. One or more of the series of the preset locations and/or audio-setups may be assigned to a user identifier (user ID), wherein the preset location and/or the audio setup may be stored together with the user ID. User-ID associated preset locations and/or audio-setups may be determined and stored, respectively, for a single listener perhaps at a preferred location, for multiple listeners, or a group of listeners—spread out at preferred/known locations in the room. The stored preset locations and/or audio-setups may be queried or retrieved, for example via an App implemented on a (mobile) user device by the single listener, any of the multiple listeners, or the group of listeners. In some embodiments, the preset locations and/or audio setups may be stored on the system and/or one or more user's devices for selection by the user. Specifically, the stored preset locations and/or audio setups may be presented to the particular listener on a display of the user's device for selection.

In some embodiments, the system and/or method may provide a, for example, selectable option for performing a sound-test for the individual user. The sound-test may be performed before carrying out a DRC-method as suggested herein and/or after finishing a DRC-method as suggested herein. In some embodiments, the method and/or system and/or App may request the listener, for example via a visual request on screen or via an audio request via the earbuds, whether the listener wants to perform a sound-test.

After receiving a confirmation from the listener, that a sound-test shall be performed, the system and/or method may provide a sound-test accordingly, for example by playing via the speakers a preset and/or user-selectable audio playback. Additionally, the earbuds may be instructed to perform a sound-test without using the speakers. Such a sound test can be used to test the listeners hearing capabilities for each ear and across the frequency range for each ear, thereby allowing the system to provide improved sound, which is also adapted to the hearing capability of the user when using the speakers.

Further, the system and/or method may, after performing the sound-test, request the listener whether the DRC-method shall additionally be performed. If a confirmation is received from the listener, for example via an oral command, or via a selection of a confirmation button presented on a screen of a user's (mobile) device, the system and/or method may proceed with performing the DRC method. If, however, a feedback from the listener is received that no DRC method shall be performed (e.g., if the sound-test is satisfactory for the user), the system and/or method may cancel DRC. Such embodiments may take account of the fact that some user's ears are different quality. Thus, the system and/or method may provide a double compensation for both the listener (in particular listener's hearing characteristics and/or preferences) and the room acoustics.

In some embodiments, alternative to or in addition to location and/or orientation detection units integrated in the earbuds 7, separate components may be used for detecting location and/or orientation, such as camera systems, or other systems, in particular optical systems, such as LIDAR (Light Detection and Ranging), etc.

In some embodiments, the DRC system 4 may read the location and/or orientation data, e.g., from TWS to earbuds 7, to determine when the user 6 has stopped moving, and, in response to that, may start to send or play the audio test signals 10 or audio test sound (or tones) 16. As a listener 6 moves the head, the system may detect, e.g. using IMU data, that the listener 6 is only rotating head but not otherwise moving, so the system may deduce that the listener 6 is still in the preferred or main listening location. In some embodiments, further measurements in this point may be used to ensure good performance also in case that listener 6 is turning the heads a bit. The same procedure may be repeated for other listening positions.

In some embodiments, the listener's distance from each of the speakers 3 may also be measured by sensor on earbud 7 or determined from the time difference between the played and recorded sounds, provided that the data transmission latency between the TWS earbuds 7 and DRC system 4 is known.

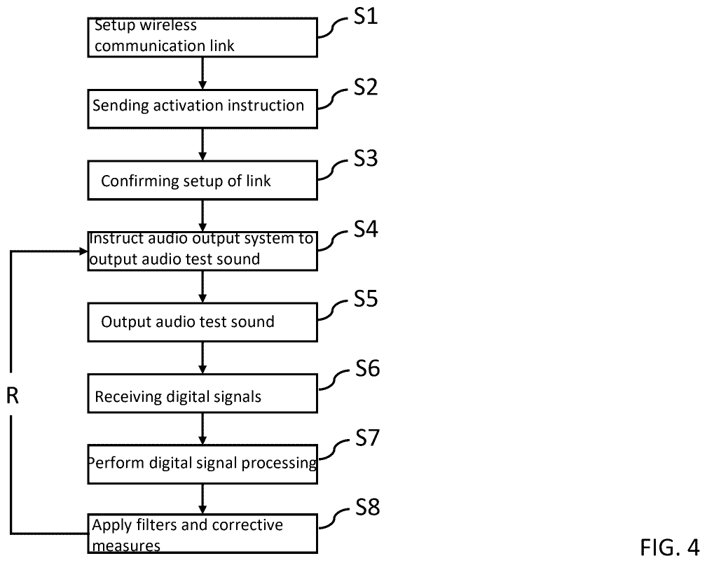

FIG. 4 shows a schematic flow diagram in connection with an exemplary DRC method according to FIG. 3. The flow diagram of FIG. 4 includes, as compared to FIG. 3, one or more optional process steps according to various embodiments. In particular, and as indicated in FIG. 4 by R, steps S4 to S8 may be carried out repeatedly. In connection with repeating these steps, the time and/or frequency domain correction filters F may be stored at least temporarily together with location and/or orientation information of the TWS earbuds 7, for application and correcting audio input signals of the audio output system 2 before outputting the audible audio via the speakers 3. That is, each earbuds'position corresponds to at least one correction filter F. In some embodiments, a listening or preferred listening location may be stored as a kind of vector including data related to an identifier for the location, a room response, one or more corrective measures, a distance from speaker etc. As an example: the vector may comprise (“main/preferred location”, “room response is X”, distance from loudspeaker 2.1 m”). Corresponding stored data may be retrieved and applied for correcting audio output.

The suggested method(s) and system(s) may utilize sweep tones or pink noise to obtain the combined frequency and time-domain response of the speaker product and the room 1. The suggested method may incorporate an embedded pulse to gain insight into the time domain.

According to some embodiments, the suggested method may incorporate measures for compensating for the time delay caused by the wireless communication protocol used for digital communication between the TWS earbuds 7 and the DRC system 4.

In some embodiments, a response compensation curve of the TWS earbuds 7 may be applied to linearize the microphones built in in the earbuds 7 for room measurement purposes.

In the context of the present disclosure, Room Impulse Response (RIR) in particular relates to an audio signal processing task that involves capturing and analyzing the acoustic characteristics of a room or an environment. The goal is to measure and model the way sound waves interact with the space, including, for example, reflections, reverberation, and echoes.

Digital room correction (DRC) in particular shall be understood as a process that involves the use of digital signal processing (DSP) techniques to adjust the audio output of a sound system to compensate for the acoustic characteristics of a room. The goal is to improve the overall sound quality by addressing issues such as reverberation, standing waves, and frequency response irregularities that occur due to the interaction of sound waves with the room's surfaces and objects.

In all, the above discussion reveals that the suggested method and system(s) solve the underlying problem.

### LIST OF REFERENCE SIGNS

1 room
2 audio output system
3 speakers
3.1 soundbar
3.2 bass speaker
3.3 satellite
4 DRC system
5 couch
6 listener
7 earbud
8 ear
9 wireless communication
10 acoustic test signal
11 activation instruction
12 confirmation
13 output instruction
14 first digital signal
15 mobile device
16 audio test sound (or tones)
F filter
I instruction
S1 . . . S7 steps
A1 . . . A3 actions
D2 . . . D3 second and third digital signals of an activation instruction
D4 fourth digital signal
D5 fifth digital signal

1. A method of automated or semi-automated digital room acoustics compensation (DRC) for an audio output system placed in a room (1) and for outputting audible audio into the room, wherein the DRC is based on room impulse response (RIR) audio signal processing, the method comprising:
establishing a wireless communication link between a DRC system and true wireless stereo (TWS) earbuds, each of the TSW earbudscomprising a microphone for capturing audio;
in response to establishing the wireless communication link, sending an activation instruction to the TWS earbud, wherein, for performing subsequent method steps, the TWS earbuds are respectively placed in a left ear and a right ear of a listener, and the activation instruction comprising instructions for activating the microphone of the TWS earbuds; and
in response to receiving a confirmation confirming successful setting up of the wireless communication link:
instructing the audio output system to output one or more audio test sound adapted to be received by the activated microphones of the TWS earbuds;
receiving, from the TWS earbuds, one or more first digital signals, each first digital signal being representative of one or more the captured audio test sound of individual audio channel;
performing digital signal processing (DSP) on the one or more first digital signals, the digital signal processing comprising room impulse response audio signal processing, to thereby generate one or more time and/or frequency domain correction filters; and
at least temporarily storing the one or more time and/or frequency domain correction filters for application.

2. The method of claim 1, further comprising applying the one or more correction filters to the audio output system before outputting audible audio via the audio output system.

3. The method of any of claim 1, wherein the wireless communication link is based on a short-range wireless communication protocol.

4. The method of claim 1, wherein the activation instruction further comprises one or more second digital signals for instructing the one or more TWS earbuds to output a first audible information via the earbud's speakers, the first audible information indicating to the listener that DRC measurement is about to be activated, is in progress, and/or was finished.

5. The method of claim 1, wherein the activation instruction further comprises one or more third digital signals for instructing the one or more TWS earbuds to output a second audible information via the earbud's speakers, the second audible information instructing the listener to move to a particular location within the room.

6. The method of claim 1, further comprising receiving from a location and/or orientation tracking unit of one or more of the TWS earbuds via the wireless communication link one or more, the fourth digital signal encoding location and/or orientation information of a respective TWS earbud, in particular relative to the audio output system, and correlating a location and/or an orientation information obtained from the fourth digital signal with one or more of the first digital signals, the first digital signal received substantially simultaneously, or immediately before or after the fourth digital signal.

7. The method of claim 1, further comprising carrying out said instructing the audio system to output one or more audio test sound, receiving, from the TWS earbuds, one more first digital signals, performing DSP and at least temporarily storing the one or more time and/or frequency domain correction filters for application, repeatedly,
wherein the time and/or frequency domain correction filters are, at least temporarily, stored together with location and/or orientation information, for application and correcting audio input signals of the audio output system before outputting the audible audio via the audio output system.

8. The method of claim 6, further comprising determining whether a location and/or orientation encoded in the fourth digital signal has changed, and, in response to determining a change, repeating said instructing the audio system to output one or more audio test sound, receiving, from the TWS earbuds, one more first digital signals, performing DSP and at least temporarily storing the one or more time and/or frequency domain correction filters for application, and at least temporarily storing previously generated correction filters together with previously determined location and/or orientation information.

9. The method of claim 1, the RIR audio signal processing comprises one or more of an analysis of the frequency response, a time representative of a delay between sending an audio signal and receiving the audio signal, an amplitude of received audio, a location of a sound source for outputting the audible audio, and an analysis of direct and reflected outputted audible audio.

10. The method of claim 1, wherein the one or more time and/or frequency domain correction filters comprises at least one of an inverting filter to correct individual audio channel's frequency response, a time-domain alignment filter to each of several audio channels so that audio of different channels arrive at the TWS earbuds substantially at a same time, an amplitude correction filter so that all channels are calibrated at predetermined value of sound pressure level, in particular at 75 dB SPL, at a listening position; phase correction filters to compensate for phase shift caused by positioning and reflective surfaces of audio output speakers.

11. The method of claim 1, further comprising establishing a further wireless link between the DRC system and a mobile communications device, the mobile communications device (15) comprising a user interface, wherein the mobile communications device is configured for receiving, from the DRC system, one or more fifth digital signals for instructing the user interface to display DRC information to a listener, and/or
the method further comprises receiving, at the DRC system, from the mobile communications device, responsive to a user-input on the user-interface, one or more sixth digital signals indicative of one or more of an indication of a location of the listener at a particular location in the room, a confirmation to start DRC, an indication of a type and configuration of the TWS earbuds, an instruction to stop DRC, and a configuration setting for the DRC.

12. A digital room acoustics compensation (DRC) system for automated or semi-automated digital room acoustics compensation for an audio output system that is placed in a room and is for outputting audible audio into the room, the DRC system comprising digital signal processing circuitry configured to, and/or comprising a non-transitory storage medium, storing instructions that when executed by one or more digital processing units, cause the DRC system to execute a method of claim 1.

13. A system comprising:
a digital room acoustics compensation (DRC) system of claim 12.

14. An audio system comprising:
a DRC system of claim 12; and
two or more audio output elements including one or more audio speakers for outputting audible audio into the room.

15. The method of claim 1, wherein, when the listener has put on the TWS earbuds and is seated in an appropriate position, the listener can perform a hand gesture for a gesture sensor of the TWS earbuds or speak to the beamforming microphones of the TWS earbuds, and upon detecting the gesture or speech, the TWS earbuds send an instruction signal to the DRC system to notify the listener has put on the TWS earbuds or is seated in the appropriate position.

16. The method of claim 1, wherein each of the TWS earbuds is equipped with a position sensor, capable of:
detecting the distance and orientation between each earbud and each speaker of the audio output system; and
generating a corresponding a relative position and orientation of the TWS earbuds, enabling the DRC system to produce a corresponding correction filter for each relative position and orientation of the earbuds, and these correction filters are stored as a lookup table, allowing the DRC system to retrieve an corresponding correction filter when it subsequently detects a relative position and orientation of the earbuds.

17. The method according to claim 1, wherein the microphone is a beamforming microphone.

18. The method according to claim 1, wherein the one or more audio test sound comprises a sequence of audio test sounds.

19. The method according to claim 1, wherein the one or more first digital signals comprises a sequence of first digital signals.

20. An audio system comprising the system of claim 13; and
two or more audio output elements including one or more audio speakers for outputting audible audio into the room.
